(19) United States
(12) Patent Application Publication
(10) Pub. No.: US 2008/0076055 A1
(43) Pub. Date: Mar. 27, 2008

(54) TONER AND DEVELOPER

(76) Inventors: Toyoshi Sawada, Hiratsuka-shi (JP); Masahide Yamada, Numazu-shi (JP); Akinori Saitoh, Numazu-shi (JP); Tomomi Suzuki, Numazu-shi (JP); Junichi Awamura, Numazu-shi (JP); Takuya Seshita, Hiratsuka-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/856,379

(22) Filed: Sep. 17, 2007

(30) Foreign Application Priority Data
Sep. 19, 2006 (JP) 2006-253498

(51) Int. Cl. G03G 9/08

(52) U.S. Cl. 430/110.3

(57) ABSTRACT

To provide a developer that includes a carrier and a toner having base particles each containing a binder resin and a paraffin wax, wherein the base particle has a paraffin wax-originated endotherm from 2.0 J/g to 5.5 J/g at an endothermic peak as measured by DSC, an average circularity from 0.94 to 1.00, and a contact area-to-whole projected area ratio from 15% to 40%.

### BACKGROUND OF THE INVENTION

1. Field of the Invention

The present invention relates to a toner and a developer.

2. Description of the Related Art

In recent years, with strong demand from the market for high-quality images at low energy consumption, much effort has been focused on developing toners (developer) which meet these requirements. Toners that can achieve high-quality image must have a small particle diameter and a sharp particle diameter distribution. When particles are uniform in diameter (i.e. the particle diameter distribution is sharp), individual toner particles behave uniformly in the development process, and the reproducibility of minute dots improves markedly. In recent years, polymerization toner production methods have been gathering attention as a method for production of toners with uniform particle diameters. Besides the suspension polymerization method, polymerization toner production methods include emulsion polymerization method and solution suspension method, which allow for preparation of different shapes comparatively simply.

For fixing the toner at low temperatures, attempts have been made to use polyester resins, which have excellent low temperature fixability and preferable heat resistance/storage stability at high temperature, in place of conventional multipurpose styrene-acryl resins. To achieve fixing at further lower temperatures, it is necessary to control heat properties of the resin. However, this introduces various problems. For instance, when the glass transition point (Tg) is lowered, heat resistance/storage stability at high temperatures deteriorates, and when a softening temperature T (F1/2) is lowered, the hot offset generation temperature decreases. Hence, even after controlling the heat properties of the polyester resin with excellent low temperature fixability, it has not been possible to prepare a toner with both an excellent low temperature fixability and a high hot offset generation temperature. Moreover, since long periods of image output result in the developer in the copying machine being stirred for long periods, toner ingredients such as a releasing agent and the low-melting-point polyester resin bind to the carrier. This tends to reduce the chargeability of the carrier, and thereby reduce the amount of charge on the developer.

If the toner particles have bumps and depressions, the silica added as a fluidizing agent transfers to, and weakly binds to the depression portions, making the toner particles more likely to contaminate the photoconductor and to be fixed to the fixing roller.

The solution suspension method has the advantage that polyester resins capable of low-temperature fixing can be used. However, as a part of control for widening a releasing latitude to achieve oilless fixing, a high-molecular weight ingredient is added when dissolving or dispersing the resin or colorant in a solvent. As a result, the solution's viscosity increases, and production problems are more likely to occur.

Japanese Patent Application Laid-Open No. 09-15903 proposes a preparation method for a toner to be used for development of latent electrostatic images, including the steps of: mixing a binder resin and a colorant in a non-aqueous solvent; dispersing the obtained composition in an aqueous medium under the presence of a dispersion stabilizing agent; forming particles having an uneven surface by removing the solvent from the obtained suspension by heating and/or vacuuming; and rounding or deforming the particles by heating. However, since the proposed toner particles are irregularly-shaped, amorphous toner particles, they lack charge stability. Moreover, they are not given with a high-molecular weight design that ensures a basic durability and releasability.

### BRIEF SUMMARY OF THE INVENTION

An object of the present invention is to provide a toner that has small particle diameter, a narrow particle diameter distribution, excellent low temperature fixability, and resists a drop in chargeability even after long periods of use, and to provide a developer containing the toner.

The following describes means for solving the problem. The present invention is:

<1> A toner including: base particles, each containing a binder resin and a paraffin wax, wherein the base particle has a paraffin wax-originated endotherm from 2.0 J/g to 5.5 J/g at an endothermic peak as measured by DSC, an average circularity from 0.94 to 1.00, and a contact area-to-whole projected area ratio from 15% to 40%.

<2> The toner according to <1>, wherein the paraffin wax has a melting point from 60° C. to 90° C.

<3> The toner according to one of <1> and <2>, wherein the whole projected area and the contact area are measured by sieving the base particles through a 22 μm mesh for 10 seconds at a position 10 cm above a substantially horizontally disposed flat glass plate so as to cause the base particles to drop onto the flat glass plate.

<4> The toner according to any one of <1> to <3>, wherein the base particle is prepared by dispersing in an aqueous medium a dispersion liquid that contains at least a polyester prepolymer having a nitrogenous functional group, a polyester, a colorant, the paraffin wax, and an inorganic filler dispersed in an organic solvent, to cause at least one of cross-linking and extension reactions of the polyester prepolymer, and

wherein the base particle has a shape factor SF1 from 130 to 160 and a shape factor SF2 from 110 to 140.

<5> The toner according to <4>, wherein the inorganic filler is one of montmorillonite and modified montmorillonite.

<6> The toner according to any one of <1> to <5>, wherein the base particle has a weight-average particle diameter (D4) from 3 μm to 8 μm, and a weight-average particle diameter (D4)-to-number-average diameter (Dn) ratio (D4/Dn) ranging from 1.00 to 1.30.

<7> The toner according to any one of <1> to <6>, further including particles having an average primary particle diameter from 50 nm to 500 nm.

<8> The toner according to any one of <1> to <7>, wherein the base particle has a glass transition point from 40° C. to 60° C.

<9> The toner according to any one of <1> to <8>, wherein base particles having a particle diameter of 2 μm or less accounts for from 1% to 10% by number of the total base particles.

<10> A developer including: a carrier; and the toner according to any one of <1> to <9>.

### BRIEF DESCRIPTION OF THE SEVERAL VIEWS OF THE DRAWINGS

FIG. 1 is an electron microscope photograph showing an example of the toner of the present invention.

FIG. 2A shows a base particle on a flat glass plate, and the region where the base particle contacts the flat glass plate (not shown).

FIG. 2B shows the base particle on the flat glass plate, and the lengths of the long and short axes of a region from which a contact area is calculated are illustrated.

FIG. 3A is an electron microscope photograph showing an example of the base particle used in the present invention on the glass flat plate.

FIG. 3B is a schematic drawing of FIG. 3A.

FIG. 4A is an electron microscope photograph showing an example of a substantially spherical base particle on the glass flat plate.

FIG. 4B is a schematic drawing of FIG. 4A.

FIG. 5A is an electron microscope photograph showing an irregularly shaped base particle on the flat glass plate.

FIG. 5B is a schematic drawing of FIG. 5A.

FIG. 6 illustrates a shape factor SF1.

FIG. 7 illustrates a shape factor SF2.

### DETAILED DESCRIPTION OF THE INVENTION

The present invention will be described below in detail referring to the drawings.

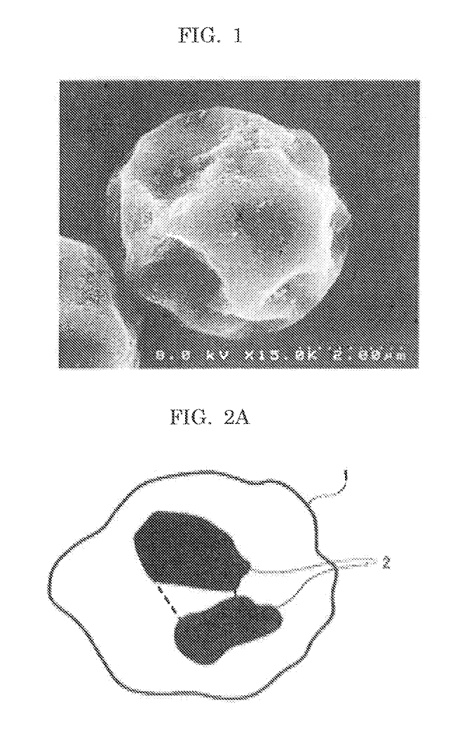

FIG. 1 shows an example of a toner of the present invention. The toner of the present invention has a base particle that includes a paraffin wax each having a melting point from 60° C. to 90° C., wherein the base particle has a paraffin wax-originated endotherm from 2.0 J/g to 5.5 J/g at an endothermic peak as measured by DSC, an average circularity of from 0.94 to 1.00, and a contact area-to-whole projecting area ratio of from 15% to 40%.

In the present invention, the average circularity of the base particles is from 0.94 to 1.00. The average circularity is measured using a flow-type particle image analyzer FPIA-2100 (made by Sysmex Ltd.) and the results are analyzed using analyzer software (FPIA-2100 Data Processing Program for FPIA version 00-10). As a condition for analysis, the particles targeted for measurement were limited to those having diameters from 2 μm to 400 μm.

In the toner of the present invention, a base particle has a ratio of the contact area D to the whole projected area S, D/S, from 15% to 40%. Generally, when the particle is on a flat surface, surface, line and point contacts are made. Here the contact surface D denotes a region that includes all of the surface, line and point contacts.

Values for D/S are measured in the manner described below. First, a flat glass plate that resembles a carrier surface (for instance, a standard transparent glass slide (thickness 2 mm)) is prepared and a 22 μm mesh sieve is prepared over the flat glass plate. Next, the base particles are loaded into the sieve, and the sieve is shaken with a vibratory motion at a height of 10 cm so as to uniformly load a small quantity of base particles onto the flat glass plate. A photograph is then taken of the flat glass plate from below using a COOL PIX 5000 (made by Nikon Co.) high performance digital camera with 4.92 million pixels. From this image it is possible to distinguish between portions of image where the base particles are in contact with the glass surface and portions of the image where the base particles are not in contact with the glass surface. The captured images are loaded into a personal computer for image analysis on Image-Pro Plus (made by Nippon Roper, Ltd.). Processing for image analysis blackens such regions as surfaces, lines and points, where the base particle is in contact with the glass surface, thereby highlighting the contacting surfaces, lines and points. Another region is then set for these regions by drawing straight lines that encompass outermost surfaces lines and points. The area of this region is the contact area D. Note that when the outermost surfaces, lines and points are to be encompassed with straight lines, the contact area D is obtained by connecting together closest surfaces lines and points while ensuring that no surfaces, lines or points exist outside the connected straight lines. During this process, when a first and a second surface are to be connected using a straight line, the straight line is drawn between points on opposing edges where a distance between the first and second surfaces is shortest. When lines (or points) are to be connected to a surface using a straight line, opposing points on an edge of the surface and on the line (or point) are connected. Next, a black line is drawn around the entire body of the base particle, and the whole projected area S is found from the area of the surrounded region. Hence, D/S can be found. The above image processing is performed for 100 or more base particles. Here, the flat glass plate resembling the carrier surface is used, because of the difficulties involved in measuring the contact area between the base particles and the carrier surface. The present methods allow the contact area to be found by making an approximation of the flat carrier surface contacted by the base particles.

Note that a D/S from 15% to 40% for the base particle indicates that the toner has a shape that enables a moderate level of contact area between the toner and the carrier. When the toner shape is near-spherical, the D/S for the base particles is less than 15% and the contact area between the toner and the carrier becomes smaller. Also, since the contacts are point contacts it is easier for the toner to roll around on the carrier surface and for components of the toner, such as the paraffin wax and resin component, to become fixed onto the carrier. This increases the risk of a drop in the chargeability of the carrier. On the other hand, when D/S for the base particle exceeds 40%, since the contacts between the toner and the carrier are surface contacts, it is harder for the toner to roll around on the carrier surface. However, since the contacts between the toner and the carrier are significantly larger, it is easier for the toner components, such as the paraffin wax and the resin component to become fixed to the carrier. This increases the risk of a drop in the chargeability of the carrier.

For the toner of the present invention, it is preferable that (an average value for) a ratio L/M, where L is a length of a long axis and M is a length of a short axis in the region used to calculate the contact area D, satisfies the relationship of equation (1).
L/M>2

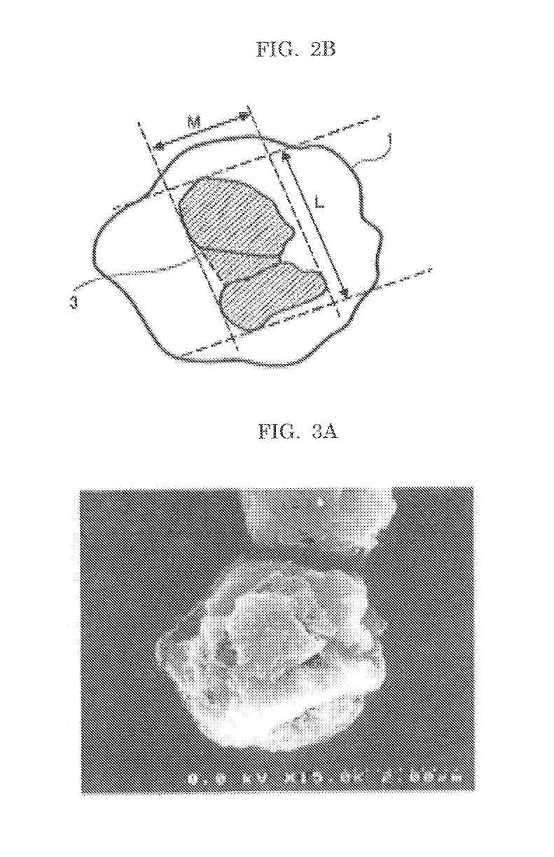

FIG. 2A shows regions 2 where the base particle 1 is in contact with the glass flat glass plate (not shown in the drawing). FIG. 2B shows the length of the long axis L and the length of the short axis M of the region 3 that is used to calculate the contact area D.

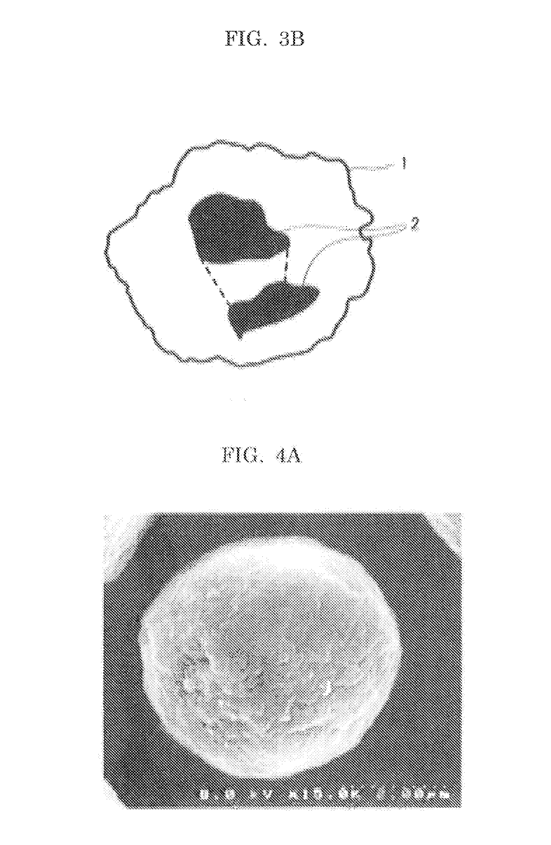

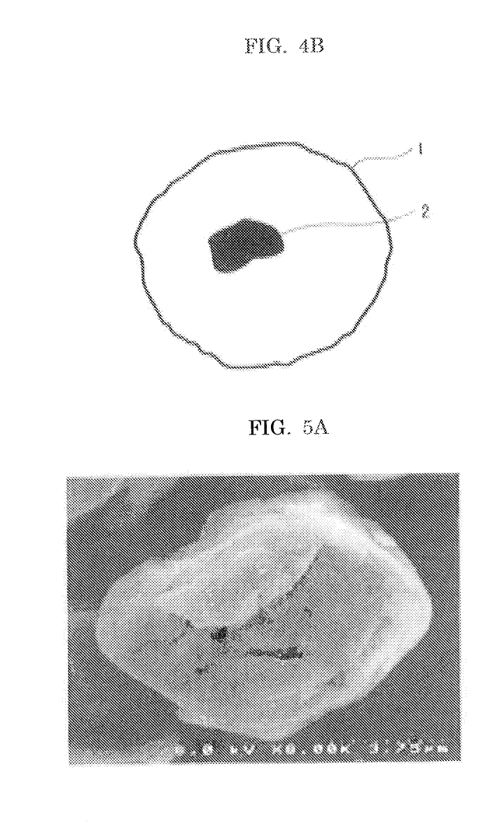

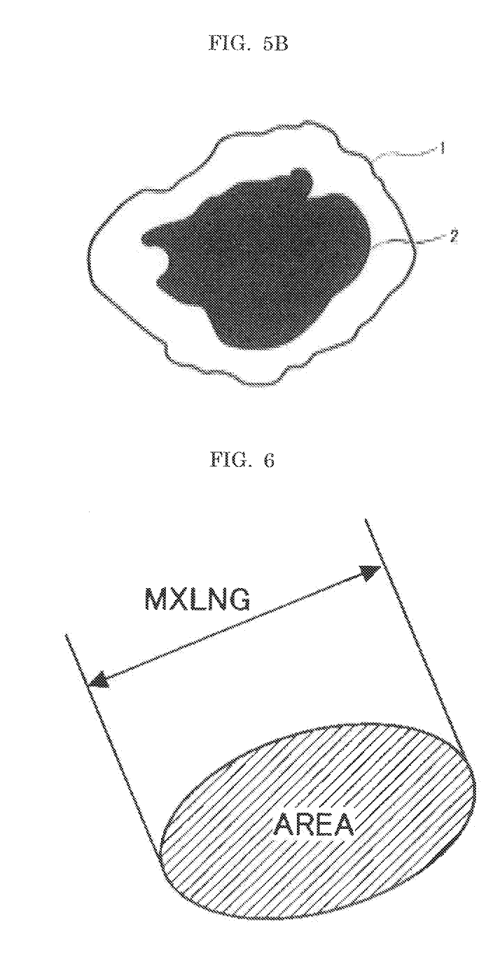

FIGS. 3A and 3B, FIGS. 4A and 4B, and FIGS. 5A and 5B show, respectively, electron microscope photographs and schematic drawings of different-shaped base particles on the flat glass plate. FIGS. 3A and 3B show a base particle 1 that is the base particle used in the present invention. In FIGS. 4A FIG. 4B, the base particle 1 is substantially spherical, and, since there is little unevenness in the surface, the contact with the flat glass plate is close to being a point contact. In FIGS. 5A FIG. 5B, the base particle 1 is an irregularly shaped particle obtained using a kneading pulverization method. Here, the contact with the flat glass plate is surface contact.

In the present invention, it is preferable that a shape factor SF1 for the base particles be from 130 to 160 and a shape factor SF2 is from 110 to 140. This allows a D/S from 15% to 40% to be achieved for the base particles, and enables the relationship in equation (1) to be satisfied.

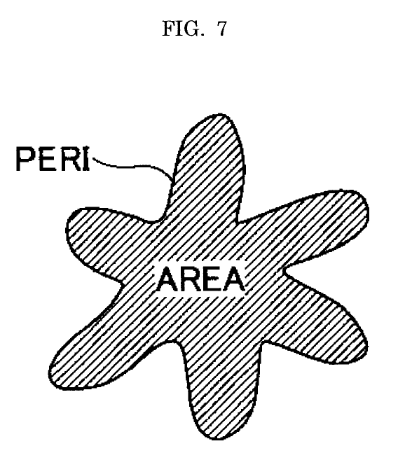

FIGS. 6 and 7 are drawings for describing a shape factor SF1 and shape factor SF2. The shape factor SF1 represents the degree of circularity, and is expressed by equation (2).
SF1={(MXLNG)²/AREA}×(100π/4) (2)
In other words, the value of SF1 is the square of a maximum length MXLNG across a 2 dimensional projection of the base particle, divided by an area AREA and multiplied by 100 π/4. When SF1 is 100, the base particle is spherical. As the value of SF1 becomes larger, the shape becomes more irregular.

The shape factor SF2 represents the level of unevenness, and is expressed using equation (3).
SF2={(PERI)²/AREA}×(100/4π) (3)
In other words, the value of SF2 is the square of a perimeter PERI across a 2 dimensional projection of the base particle divided by the area AREA and multiplied by 100/4π. When SF2 is 100, the surface of the base particle is completely even. As the value of SF2 becomes larger, the unevenness becomes more marked.

To find the shape factors, photographs of the base particles were taken using an S-800 scanning electron microscope (made by Hitachi, Ltd.), and the obtained images were input into a LUSEX 3 image analyzer (made by Nireko Co.). Analysis and calculations were performed on 100 base particles.

The toner of the present invention preferable has an increased content of paraffin wax for improved hot offset resistance. However, since paraffin wax adheres easily to the carrier, to maintain the chargeability over long periods, it is preferable to reduce the paraffin wax content. Hence, the base particles have, as a measure of paraffin wax content, a paraffin wax-originated endothermic peak with an endotherm in a range of 2.0 J/g to 5.5 J/g, as measured by DSC.

It is preferable that the glass transition point (Tg) for the base particles be from 40° C. to 60° C. If the glass transition point (Tg) is less than 40° C., the heat resistance of the toner may fall. If more than 60° C., the low temperature fixing performance may be inadequate. When a modified polyester such as an urea-modified polyester resin is included, the toner of the present invention has a favorable heat resistance/storage stability at high temperatures compared with known polyester-type toners, even when the glass transition point is low.

The glass transition point (Tg) was measured using a TA-60WS measuring device and a DSC-60 (made by Shimadzu Co.) and the following measurement conditions.

Sample container: aluminum sample pan (including lid)

Sample: base particles 5 mg

Reference: aluminum sample pan (aluminum 10 mg)

Atmosphere: nitrogen (flow rate: 50 ml/minute)

Temperature conditions
Starting temperature: 20° C.
Temperature rise: 10° C./minute
Ending temperature: 150° C.
Holding time: none
Temperature drop: 10° C./minute
Ending temperature: 20° C.
Holding time: none
Temperature rise: 10° C./minute
Ending temperature: 150° C.

The measured results where analyzed using TA-60, version 1.52 data analysis software (made by Shimadzu Co.).

The heat absorption at the heat absorption peak for paraffin wax on a DSC is found by specifying, on a DrDSC curve that is the second temperature rise DSC differential curve, two points on a base line on high and low temperature sides of a heat absorption peak that corresponds to the heat absorption when the paraffin wax is melting, and using a peak analysis function on the analysis software. Note that the heat absorption peak corresponding to the heat absorption when the paraffin wax is melting can be found by performing DSC measurements on paraffin wax alone in accordance with the above procedure.

The glass transition point (Tg) for the base particles is found as follows. A range of ±5° C. is specified around a largest peak on the low temperature side of the DrDSC curve that is the second temperature—increasing differential curve, and a peak temperature is found using the peak analyzing function of the analysis software. Next, a maximum heat absorption temperature is found using the peak analysis function of the analysis software in the +5° C. to −5° C. range around the obtained peak temperature. The obtained maximum heat absorption temperature corresponds to the glass transition point (Tg) of the binder resin.

To enable the toner of the present invention to reproduce minute dots of 600 dpi and above, it is preferable that the weight-average diameter (D4) of the base particles be 3 μm to 8 μm. It is also preferable that the base particles have a ratio between the weight-average particle diameter (D4) and the number-average particle diameter (Dn), (D4/Dn), of 1.00 to 1.30. The nearer D4/Dn is to 1.00, the sharper the particle diameter distribution becomes. For similar reasons, it is preferable that the content of base particles with a particle diameter of 2 μm or less be 1% to 10% of the base particles on a number basis. When the base particles have this type of small diameter and narrow particle diameter distribution, the charge distribution in the toner is uniform and high-quality images with little background fog can be obtained. Moreover, the developing efficiency of the electrostatic transfer methods can be improved. On the other hand, it is generally the case that toners having small particle diameters also have a stronger non-electrostatic binding to the carrier. As a result, the base particles stay longer on the surface of the carrier, and are more susceptible to stirring stress. As a result, the toner fixes to the carrier surface and causes the problem of a reduction in the chargeability of the carrier. To prevent this type of problem, it is preferable that the content of base particles with a particle diameter of 2 μm or less be 1% to 10% of the total base particles on a number base.

The particle size distribution for the base particles is measured using the Coulter counter method. Examples of measuring devices used in this method include the Coulter Counter TA-II and the Coulter Multisizer II (both made by Beckman Coulter). The following describes the measurement method.

First, 0.1 ml to 5 ml of a surfactant (preferably alkyl benzene sulfonate) is added as a dispersant to 100 ml to 150 ml of electrolyte solution. A 1% NaCl aqueous solution is prepared as an electrolyte solution using class-1 sodium chloride. For example an ISOTON-II (made by Coulter Electronics Ltd.) can be used. Then, 2 mg to 20 mg of test material is added. The suspension of the electrolyte solution and the test material undergoes approximately minute 1 to 3 minutes of dispersion processing using an ultrasonic dispersing device. Then, the volume and number of base particles are measured by one of the above measuring devices using a 100 μm aperture, and the weight distribution and number distribution are calculated. The weight-average particle diameter (D4) and the number-average particle diameter (Dn) are found from the obtained distributions.

Thirteen channels are used: from 2.00 μm up to but not including 2.52 μm; from 2.52 μm up to but not including 3.17 μm; 3.17 μm up to but not including 4.00 μm; from 4.00 μm up to but not including 5.04 μm; from 5.04 μm up to but not including 6.35 μm; from 6.35 μm up to but not including 8.00 μm; from 8.00 μm up to but not including 10.08 μm; from 10.08 μm up to but not including 12.70 μm; from 12.70 μm up to but not including 16.00 μm; from 16.00 μm up to but not including 20.20 μm; from 20.20 μm up to but not including 25.40 μm; from 25.40 μm up to but not including 32.00 μm; and from 32.00 μm up to but not including 40.30 μm. Thus, particle diameters from 2.00 μm up to but not including 40.30 μm can be used.

The content of base particles with particle diameters of 2 μm or less is measured using an FPIA-2100 flow-type particle image analyzer (made by Sysmex Corporation), and analyzed on analysis software (FPIA-2100 Data Processing Program for FPIA version 00-10). Specifically, 0.1 ml to 0.5 ml of 10 weight percent surfactant (alkyl benzene sulfonate neogen SC-A; made by Dai-Ichi Kogyo Seiyaku Co.) aqueous solution and 0.1 g to 0.5 g of test material are added to a 100 ml glass beaker. The contents are then mixed using a microspatular, and 80 ml of ion-exchanged water are added. The obtained dispersion liquid undergoes 3 minute-dispersion treatment using an ultrasound dispersion device (made by Honda Electronics Co.). The shape and particle size distribution for the base particles are measured until the concentration reaches 5000 particles/μl to 15000 particles/μl. This measurement method allows measurement of average circularity. However, to ensure reproducibility of the measurements, it is important that the concentration of the dispersant liquid be 5000 particles/μl to 15000 particles/μl. To obtain this concentration in the dispersion liquid, it is necessary to vary the amounts of surfactant and test material added thereto. The amount of surfactant required differs depending on hydrophobic properties of the base particles. When the amount added is large, noise is generated by bubbles. When the amount added is small, the base particles cannot be sufficiently wetted, and so the dispersion is inadequate. The amount of test material required differs according to particle diameter. With small particle diameters the amount must be reduced. With large particle diameters, the amount must be increased. When the weight-average particle diameter is 3 μm to 8 μm, adding 0.1 g to 0.5 g of test material allows the concentration of the dispersant liquid to be set at 5000 particles/μl to 15000 particles/μl.

In the present invention, it is preferable that the binder resin contain a modified polyester (i). A modified polyester (i) means a polyester resin that has functional groups other than oxycarbonyl group (—COO—), or a polyester resin in which different resin component(s) are bonded by covalent bonding, ionic bonding or the like. Examples of the modified polyester (i) include those obtained introducing at a polyester resin terminal a functional group such as isocyanate group that reacts with carboxyl and hydroxyl groups, and allowing the polyester resin to reacted with a active hydrogen-containing compound. Specific examples include an urea-modified polyester that is obtained by cross-linking and/or extension reactions between an isocyanate group-containing polyester prepolymer (A) and an amine (B).

Examples of the isocyanate group-containing polyester prepolymer (A) include the polycondensation product of polyol (PO) and a polycarboxylic acid (PC) and the product of reacting a polyester that includes an active hydrogen group with a polyisocyanate (PIC). Examples of the active hydrogen group included in the polyester include hydroxyl groups (alcoholic hydroxyl group and phenolic hydroxyl group), amino group, carboxyl group, and mercapto group, but the alcoholic hydroxyl group is preferable.

Examples of the polyol (PO) include a mixture of diols (DIO) and polyols having 3 or more hydroxyl groups (TO). However the (DIO) or a mixture of the (DIO) with a small quantity of the (TO) is preferable. Examples of the diols (DIO) include alkylene glycols (such as ethylene glycol, 1,2-propylene glycol, 1,3-propylene glycol, 1,4-butane diol, and 1,6-hexanediol); alkylene ether glycols (such as diethylene glycol, triethylene glycol, dipropylene glycol, polyethylene glycol, polypropylene glycol, and polytetramethylene ether glycol); alicyclic diols (such as 1,4-cyclohexanedimethanol and hydrogenated bisphenol A); bisphenols (such as bisphenol A, bisphenol F, and bisphenol S); alkylene oxide additives (such as ethylene oxide, propylene oxide, and butylene oxide) of the above alicyclic diols; and alkylene oxide additives (such as ethylene oxide, propylene oxide, and butylene oxide) of the above bisphenols. However, the diol (DIO) is preferably a 2 to 12 carbon alkylene glycol with an added bisphenol alkylene oxide, and particularly preferably a combination of the bisphenol alkylene oxide and the 2 to 12 carbon alkylene glycol. Examples of (TO) include multivalent aliphatic alcohols having 3 to 8 valences (such as glycerin, trimethylolethane, trimethylolpropane, pentaerythritol, and sorbitol); phenols having 3 or more valences (such as trisphenol PA, phenolnovolak, cresolnovolak); and adducts of the above mentioned polyphenol having 3 or more valences with an alkylene oxide.

As the polycarboxylic acid (PC), dicarboxylic acids (DIC) and polycarboxylic acids having three or more carboxylic groups (TC) can be used. (DIC) alone, or a mixture of (DIC) and a small amount of (TC) are preferably used. Specific examples of dicarboxylic acids (DIC) include alkylene dicarboxylic acids (such as succinic acid, adipic acid and sebacic acid); alkenylene dicarboxylic acid (such as maleic acid and fumaric acid); and aromatic dicarboxylic acids (such as phthalic acid, isophthalic acid, terephthalic acid, and naphthalene dicarboxylic acid). In particular, alkenylene dicarboxylic acid having 4 to 20 carbon atoms and aromatic dicarboxylic acid having 8 to 20 carbon atoms are preferably used. Specific examples of the polycarboxylic acid having three or more carboxylic groups (TC) include aromatic polycarboxylic acids having 9 to 20 carbon atoms (such as trimellitic acid and pyromellitic acid). Rather than using a polycarboxylic acid (PC), an anhydride or lower alkyl ester (such as methyl ester, ethyl ester or isopropyl ester) of the polycarboxylic acid (PC) may be caused to react with the polyol (PO).

The polyol (PO) and polycarboxylic acid (PC) are mixed so that the equivalent ratio [OH]/[COOH] between a hydroxyl group OH and a carboxyl group COOH is typically from 2/1 to 1/1, preferably from 1.5/1 to 1/1, and more preferably from 1.3/1 to 1.02/1.

Specific examples of the polyisocyanate (PIC) include aliphatic polyisocyanates (such as tetramethylenediisocyanate, hexamethylenediisocyanate, and 2,6-diisocyanatemethylcaproate); alicyclic polyisocyanates (such as isophoronediisocyanate and cyclohexylmethanediisocyanate); aromatic diisocyanates (such as tolylenediisocyanate and diphenylmethanediisocyanate; araliphatic diisocyanates (such as a,a,a′,a′-tetramethylxylylenediisocyanate); and isocyanates, where they may be used in combination. Polyisocyanates (PIC) blocked with phenol derivatives, oximes or caprolactams may also be used instead.

When the polyisocyanate (PIC) is reacted with polyester having the hydroxyl groups, the equivalent ratio [NCO]/[OH] at reaction between the isocyanate groups NCO and the hydroxyl groups OH is typically from 5/1 to 1/1, preferably from 4/1 to 1.2/1, and more preferably from 2.5/1 to 1.5/1. When [NCO]/[OH] is greater than 5, the low temperature fixability of the resultant toner may deteriorate. When [NCO]/[OH] is less than one, the urea bond content in the urea-modified polyester decreases and the hot offset resistance may decrease.

The polyisocyanate (PIC) content in the isocyanate group-containing polyester prepolymer (A) is typically from 0.5% by mass to 40% by mass, preferably from 1% to 30% by mass, and more preferably from 2% by mass to 20% by mass. When the content is less than 0.5% by mass, the hot offset resistance may be lower, as do the high temperature heat resistance/storage stability and the low temperature fixability. On the other hand, when the content is greater than 40% by mass, the low temperature fixability may deteriorate.

Preferably the average number of the isocyanate groups included per molecule of the isocyanate group-containing prepolymer (A) is, typically, 1 or more, more preferably from 1.5 to 3, and further more preferably from 1.8 to 2.5. When the number of isocyanate groups is less than 1 per molecule, the molecular is weight of the urea-modified polyester decreases and the hot offset resistance may be lower.

Specific examples of the amines (B) include diamines (B1), polyamines (B2) having three or more amino groups, amino alcohols (B3), amino mercaptans (B4), and amino acids (B5). However, it is preferable to have the diamines (B1) alone or a mixture of the diamines (B1) with a small quantity of the polyamines (B2) having three or more amino groups. Specific examples of the diamines include aromatic amines (such as phenylene diamine, diethyltoluene diamine and 4,4′-diaminodiphenyl methane); alicyclic diamines (such as 4,4′-diamino-3,3′-dimethyldicyclohexyl methane, diamine cyclohexane, and isophorone diamine); aliphatic diamines (such as ethylene diamine, tetramethylene diamine and hexamethylene diamine). Specific examples of the polyamines (B2) having three or more amino groups include diethylene triamine and triethylene tetramine. Specific examples of the amino alcohols (B3) include ethanol amine and hydroxylethyl aniline. Specific examples of the aminomercaptan (B4) include aminoethyl mercaptan and aminopropyl mercaptan. Specific examples of the amino acids include amino propionic acid and amino caproic acid. Amines (B) having the amino group(s) blocked may be used instead of the amines (B). Specific examples of the blocked amines include ketimine compounds, which are prepared by reacting one of the amines (B) with a ketone (such as acetone, methyl ethyl ketone or methyl isobutyl ketone), and oxazolidine compounds.

The mixing ratio at reaction between the isocyanate group-containing polyester prepolymer (A) and the amines (B) (equivalent to a ratio [NCO]/[NHx], where NCO denotes the isocyanate groups and NHx denotes the amino groups) is preferably typically from 1/2 to 2/1, more preferably from 1.5/1 to 1/1.5, and further more preferably from 1.2/1 to 1/1.2. When [NCO]/[NHx] is greater than 2/1 or less than ½, the molecular weight of the urea-modified polyester may decrease, resulting in a reduction of the hot offset resistance.

In cross-linking and/or extension reactions between the polyester prepolymer (A) and the amine (B), the molecular weight of the obtained urea-modified polyester can be controlled according to requirements using a reaction terminator. Specific examples of the reaction terminator include monoamines (such as diethyl amine, dibutyl amine, butyl amine and lauryl amine). Note that ketimine compounds prepared by blocking the monoamines may be used in place of the monoamines.

The urea-modified polyester may also contain urethane bonds. The molar ratio of urethane bonds with respect to urea bonds is preferably typically from 0/1 to 9/1, more preferably from 1/4 to 4/1, and further more preferably from 2/3 to 7/3. When the molar ratio is greater than 9 the hot offset resistance may be lower.

The modified polyester (i) is manufactured using a one-shot method and a prepolymer method. The average molecular weight for the modified polyester (i) is preferably typically 10,000 or more, is more preferably 20,000 to 10,000,000, and is further more preferably 30,000 to 1,000,000. The peak molecular weight for the modified polyester (i) is preferably from 1,000 to 10,000. When the peak molecular weight is less than 1,000, the elasticity of the toner decreases and the hot offset resistance may be lower. When the peak molecular weight exceeds 10,000, the fixability may be reduced and manufacturing problems are more likely to occur when forming the particles or during pulverization. When the modified polyester (i) is used in combination with the unmodified polyester (ii) described below, there is no particular limit on the number-average molecular weight of the modified polyester (i). When the modified polyester (i) is used alone, the number-average molecular weight for the modified polyester (i) is preferably typically 20,000 or less, is more preferably 1,000 to 10,000, and further more preferably 2,000 to 8,000. When the number-average molecular weight exceeds 20,000, the low temperature fixability and, in the case of a color device, the glossiness of color images deteriorate.

In the present invention, the binder resin may include an amount of the unmodified polyester (ii) together with the modified polyester (i). Combining the unmodified polyester (ii) with the modified polyester (i) improves the low temperature fixability and, in the case of the color device, the glossiness of the produced images. Suitable unmodified polyesters (ii) include the same polycondensation products of the polyols (PO) and the polycarboxylic acids (PC) as the above-described modified polyester (i). In addition, when an urea-modified polyester is used as the modified polyester (i), a polyester using some bonding other than urea bonding, such as urethane bonding, may be used in place of the unmodified polyester (ii). To improve the low temperature fixability and the hot offset resistance, it is preferable that the modified polyester (i) be miscible at least partially with the unmodified polyester (ii). Hence, the modified polyester (i) preferably has a structure similar to that of the unmodified polyester (ii). Generally, the mixing ratio for the modified polyester (i) with respect to the unmodified polyester (ii) is preferably from 5/95 to 80/20, more preferably from 5/95 to 30/70, further more preferably from 5/95 to 25/75, and even more preferably from 7/93 to 20/80. When the mixing ratio is less than 5/95, the hot offset resistance may be lower, as do the high temperature heat resistance/storage stability and the low temperature fixability.

Generally, the peak molecular weight for the unmodified polyester (ii) is preferably from 1,000 to 10,000, more preferably from 2,000 to 8,000, and even more preferably from 2,000 to 5,000. When the peak molecular weight is less than 1,000, the high temperature heat resistance/storage stability deteriorates, and when greater than 10,000, the low temperature fixability may be reduced. The unmodified polyester (ii) preferably has a hydroxyl group value of 5 mg KOH/g or more, more preferably from 10 mg KOH/g to 120 mg KOH/g, and even more preferably from 20 mg KOH/g to 80 mg KOH/g. When the hydroxyl group value is less than 5 mg KOH/g, the high temperature heat resistance/storage stability and the low temperature fixability are adversely affected. The acid value for the unmodified polyester (ii) is preferably from 1 mg KOH/g to 5 mg KOH, and more preferably from 2 mg KOH/g to 4 mg KOH/g. A wax with a high acid value is easily matched to a toner used in a two-component type developer because a binder resin with low acid value gives rise to charge and high volume resistance.

Generally, the binder resin has a glass transition point (Tg) that is preferably from 35° C. to 70° C., and more preferably from 55° C. to 65° C. When the Tg is less than 35° C., the high temperature heat resistance/storage stability deteriorates, and when greater than 70° C., the low temperature fixability becomes inadequate. Since the urea-modified polyester tends to exist on the surface of the obtained base particles, the toner of the present invention has a better high temperature heat resistance/storage stability than known polyester-based toners even though the glass transition point is low.

The following describes a manufacturing method for the binder resin. The urea-modified polyester, which is one example of the modified polyester (i), can be manufactured using the following method. The polyester with hydroxyl groups is obtained by heating the polyol (PO) and the polycarboxylic acid (PC) with an esterification catalyst such as tetrabutoxytitanate or dibutyl tin oxide at 150° C. to 280° C. and, and removing the produced water by distillation, where necessary under a reduced pressure. Next, the polyester is reacted with the polyisocyanate (PIC) at 40° C. to 140° C., to obtain the isocyanate group-containing prepolymer (A). The isocyanate group-containing prepolymer (A) is then reacted with the amine (B) at 0° C. to 140° C. to obtain the urea-modified polyester.

In the reactions between the polyester and the polyisocyanate (PIC) and between the isocyanate group-containing prepolymer (A) and the amine (B), a solvent may be used according to requirements. Suitable solvents are solvents that are inert to the polyisocyanate (PIC), and examples include aromatic solvents (such as toluene and xylene); ketones (such as acetone, methyl ethyl ketone, and methyl isobutyl ketone); esters (such as ethyl acetate); amides (such as dimethylformamide and dimethylacetamide) and ethers (such as tetrahydrofuran).

When a combination of the modified polyester (i) and the unmodified polyester (ii) is used as the binder resin, the unmodified polyester is prepared in the same manner as the polyester having the hydroxyl group, and the prepared unmodified polyester (ii) is added to and dissolved in a solution of the modified polyester (i) after completion of the reaction.

Note that in the present invention, materials other than the modified polyester (i) and the unmodified polyester (ii) can be used as the binder resin. These include styrene and substituted styrene polymers such as polystyrene, poly-p-chlorostyrene and polyvinyltoluene; copolymers of such styrenes and vinyl-compounds; and other resins such as polymethyl methacrylate, polybutylmethacrylate, polyvinyl chloride, polyvinyl acetate, polyethylene, polypropylene, polyesters, epoxy resins, epoxy polyol resins, polyurethane, polyamide resins, polyvinyl butyral resins, polyacrylic resins, rosins, modified rosins, terpene resins, aliphatic or alicyclic hydrocarbon resins, aromatic petroleum resins, chlorinated paraffin, and paraffin waxes. These binder resins may be used alone or in combination.

In the present invention as well as the binder resin and the paraffin wax with a melting point from 60° C. to 90° C., the base particles can also contain a colorant, a charge controlling agent, an inorganic filler, etc.

Known dyes and colorants can be used as the colorant. Specific examples of the colorants include carbon black, Nigrosine dyes, black iron oxide, Napthol Yellow S, Hansa Yellow (10G, 5G, and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-cholo-o-nitroaniline red, Lithol-Fast Scarlet G, Brilliant Fast Scarlet, Brilliant Carmine BS, Permanent Red (F2R, F4R, FRL, FRLL and F4R), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosing Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Fast Sky Blue, Indanthene Blue (RS and BC), Indigo, ultramarine, Prussian Blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and the like. These materials may be used alone or in combination.

Generally, the content of the colorant in the base particles is preferably from 1% by mass to 15% by mass, and more preferably from 3% by mass to 10% by mass.

The colorant can be used as a Master Batch pigment when combined with a resin. Specific examples of the resin used in Master Batch production or kneaded together with the Master Batch include styrene polymers and substituted styrene polymers such as polystyrene, poly-p-chlorostyrene, polyvinyltoluene, and vinyl-compounds and combinations thereof; and other resins such as polymethyl methacrylate, polybutylmethacrylate, polyvinyl chloride, polyvinyl acetate, polyethylene, polypropylene, polyesters, epoxy resins, epoxy polyol resins, polyurethane, polyamide resins, polyvinyl butyral resins, polyacrylic resins, rosins, modified rosins, terpene resins, aliphatic or alicyclic hydrocarbon resins, aromatic petroleum resins, chlorinated paraffin, and paraffin waxes. These resins may be used in combination.

The Master batch can be prepared by mixing and kneading the resin and the colorant through application of a high shear force. An organic solvent can be used to improve the interaction of the colorant with the resin. A method known as flushing method may be used. In the flushing method, an aqueous paste including the colorant is mixed with the resin and an organic solvent, the colorant is transferred to a resin side, and the water and organic solvent are removed. When the flushing method is used, a colorant wetcake can be used in its original form. A shear force dispersion device such as a three roll mill is preferably used for the mixing and kneading.

Known materials can be used as the charge controlling agent. Examples include Nigrosine dyes, triphenylmethane dyes, metal complex dyes containing chromium, chelate compounds of molybdic acid, Rhodamine dyes, alkoxyamines, quaternary ammonium salts (including fluorine-modified quaternary ammonium salts, alkylamides, phosphor and compounds including phosphor, tungsten and compounds including tungsten, fluorinated surfactants, metal salts of salicylic acid, and salicylic acid derivatives. Specific examples of charge controlling agents include BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid) and E-89 (phenolic condensation product), which are made by Orient Chemical Industries Co., Ltd.; TP-302 and TP-415 (molybdenum complex of quaternary ammonium salt) which are made by Hodogaya Chemical Co., Ltd.; COPY CHARGE PSY VP2038 (quaternary ammonium salt), COPY BLUE PR (triphenylmethane derivative), and COPY CHARGE NEG VP2036 and COPY CHARGE NX VP434 (quaternary ammonium salt), which are made by Hoechst AG; and LRA-901 and LR-147 (boron complex), which are made by Japan Carlit Co. Ltd. Other examples include copper phthalocyanine, peryene, quinacridone, azo pigments, and polymers having a functional group such as a sulfonate group, a carboxyl group, a quaternary ammonium group, or the like. Of these, materials that control the toner to a negative polarity are preferable.

The amount of charge controlling agent to be added is determined depending on the type of binder resin used, on the presence of additive agent, and on whether the toner manufacturing method includes the dispersion method, but is not limited in any particular way. However, the amount of charge control agent is preferably from 0.1% by mass to 10% by mass, and more preferably 0.2% by mass to 5% by mass of the binder resin. When the added amount exceeds 10% by mass, the chargeability of the toner becomes excessive, and the effectiveness of the charge controlling agent is reduced. The electrostatic force towards a developing roller increases, causing a reduction in the fluidity of the developer and a decrease in image density.

The inorganic filler is used to control the shape of the base particles, and is preferably montmorillonite or an organic modification thereof (CLAYTONE APA). The function of the inorganic filler is to roughen the surface of the base particles, and the mechanism of this process is described below. At the emulsion stage in a toner production process by which a dispersion liquid, which is an organic solvent having toner components dispersed therein, is emulsified in an aqueous medium in the presence of a surfactant and fine resin particles, the inorganic filler transfers to the boundaries of the organic solvent and the aqueous medium and collects on the surface of an emulsion dispersion. Next, the organic solvent is removed from the emulsion dispersion, and the inorganic filler on the surface of the base particles introduces unevenness during processes to wash and dry the base particles.

The content of the inorganic filler in the base particles is preferably from 0.1% by mass to 10% by mass. With this method, the shape of the base particle can be controlled. As the inorganic filler content increases, the values of SF1 and SF2 increase and the shape of the base particles changes.

In the present invention, the base particles may be used in their original form as the toner. However, to aid the flowability, developing properties, and chargeability of the toner, it is preferable to add inorganic particles as an external additive. It is preferable that the inorganic fine particles have an average primary particle diameter from 50 nm to 500 nm. Also, the specific surface area, as determined by the BET method, is preferably from 20 m²/g to 500 m²/g. The inorganic particle content of the toner is preferably from 0.01% by mass to 5% by mass, and more preferably from 0.01% by mass to 2.0% by mass.

Examples of materials used for the inorganic particles include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, iron oxide red, anitimony trioxide, magnesium oxide, zirconium oxide, barium sulfate, barium carbonate, calcium carbonate, silicon carbide, and silicon nitride.

Other than the inorganic particles, examples of the external additive include polymer particles such as polystyrene and copolymers of methacrylic esters or acrylic esters which are prepared by soap-free emulsion polymerization, suspension polymerization or dispersion polymerization; silicone resins, benzoguanamine resins, nylon resins and other polycondensed or thermosetting resins.

A surface treatment may be performed on these external additives. Such a treatment improves hydrophobic properties of the external additives, preventing decreases in flowability and chargeability, even in humid conditions. Suitable surface treatment agents include a silane coupling agent, a silating agent, a silane coupling agent having an fluorinated alkyl group, an organic titanate coupling agent, an aluminum coupling agent, a silicon oil, and a modified silicon oil. Of these, hydrophobic silica and hydrophobic titanium oxide prepared through surface treatment of silica and titanium oxide are particularly preferable as external additives.

The following describes a production process for the toner of the present invention. The following describes a preferable production process, but the present invention is not limited to the described method.

(1) The unmodified polyester (i), isocyanate group-containing prepolymer (A), colorant, paraffin wax having a melting point from 60° C. to 90° C., and inorganic filler are dispersed in an organic solvent to prepare a toner ingredient liquid.

For easy removal, it is preferable that the organic solvent is volatile with a boiling point of less than 100° C. Such solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. Of these, the preferred solvents are toluene, xylene and other aromatic solvents; and methylene chloride, 1,2-dichloroethane, chloroform, carbon tetrachloride, and other halogenated hydrocarbons. The solvents may also be used in combination. The amount of the organic solvent is generally from 0 to 300 parts by mass, preferably from 0 to 100 parts by mass, and more preferably from 25 parts by mass to 70 parts by mass, per 100 parts of the isocyanate group-containing prepolymer (A).

(2) An emulsion is prepared by forming an emulsion of the toner ingredient liquid in the aqueous medium.

The aqueous medium may be water alone, or may be a mixture that includes an organic solvent. Examples of such solvents include alcohols (such as methanol, isopropyl alcohol, ethylene glycol), dimethylformamide, tetrahydrofuran, cellosolves (such as methyl cellosolve), lower ketones (such as acetone and methyl ethyl ketone). The amount of the aqueous medium is preferably typically from 50 parts by mass to 2,000 parts by mass, and more preferably from 100 parts by mass to 1,000 parts by mass per 100 parts of the toner ingredient liquid. When the amount of the aqueous medium is less than 50 parts by mass, it results in poor dispersion of the toner ingredient liquid in the aqueous medium, and the resultant base particles may fail to have a desired diameter. On the other hand, when the amount of the aqueous medium exceeds 2,000 parts by mass, the production process is uneconomic. To improve dispersion of the toner ingredient liquid in the aqueous medium, an appropriate amount of a dispersion agent such as a surfactant and/or a resin fine-particle dispersant can be added.

Specific examples of the surfactants include anionic surfactants such as alkylbenzenesulfonic acid salts, α-olefin sulfonic acid salts, and phosphate salts; amine salt-type cationic surfactants such as alkyl amine salts, aminoalcohol fatty acid derivatives, polyamine fatty acid derivatives and imidazoline; quaternary ammonium salt-type surfactants such as alkyltrimethylammonium salts, dialkyldimethylammonium salts, alkyldimethyl benzyl ammonium salts, pyridinium salts, alkyl isoquinolinium salts, and benzethonium chloride; nonionic surfactants such as fatty acid amide derivatives, polyhydric alcohol derivatives; and ampholytic surfactants such as alanine, dodecylbis(aminoethyl)glycine, bis(octylaminoethyl)glycine, and N-alkyl-N,N-dimethylammonium betaine.

Use of a fluoroalkyl group-containing surfactant can make the added amount of surfactant small. Specific examples of anionic fluoroalkyl group-containing surfactants include fluoroalkyl carboxylic acids having 2 to 10 carbon atoms and their metal salts, disodium perfluorooctanesulfonylglutamate, sodium 3-[ω-fluoroalkyl(C6-C11)oxy]-1-alkyl(C3-C4) sulfonate, sodium 3-[ω-fluoroalkanoyl(C6-C8)-N-ethylamino]-1-propanesulfonate, fluoroalkyl(C11-C20) carboxylic acids and their metal salts, perfluoroalkylcarboxylic acids and their metal salts, perfluoroalkyl(C4-C12)sulfonate at its metal salts, perfluoroocatanesulfonic acid diethanol amides, N-propyl-N-(2-hydroxyethyl)perfluorooctanesulfone amide, perfluoroalkyl(C6-C10) sulfoneamide propyltrimethylammonium salts, perfluoroalkyl(C6-C10)-N-ethylsulfonyl glycin salts, monoperfluoroalkyl(C6-C16)ethylphosphates.

Specific examples of the marketed products of such fluoroalkyl group-containing surfactants include SURFLON S-111, S-112 and S-113 (made by Asahi Glass Co., Ltd.); FRORARD FC-93, FC-95, FC-98 and FC-129 (made by Sumitomo 3M, Ltd.); UNIDYNE DS-101 and DS-102 (which are made by Daikin Industries, Ltd.); MEGAFACE F-110, F-120, F-113, F-191, F-812 and F-833 (made by Dainippon Ink and Chemicals, Inc.); ECTOP EF-102, 103, 104, 105, 112, 123A, 123B, 306A, 501, 201 and 204 (made by Tohchem Products Co., Ltd.); and FUTARGENT F-100 and F150 (made by Neos Co., Ltd.).

Specific examples of the cationic surfactants include primary and secondary aliphatic amines having a fluoroalkyl group, aliphatic quaternary ammonium salts such as perfluoroalkyl(C6-C10) sulfone amide propyltrimethylammonium salts, benzalkonium salts, benzethonium chloride, pyridinium salts, and imidazolinium salts. Specific examples of the marketed products thereof include SURFLON S-121 (made by Asahi Glass Co., Ltd.); FRORARD FC-135 (made by Sumitomo 3M Ltd.); UNIDYNE DS-202 (made by Daikin Industries, Ltd.); MEGAFACE F-150 and F-824 (made by Dainippon Ink and Chemicals, Inc.); ECTOP EF-132 (made by Tohchem Products Co., Ltd.); and FUTARGENT F-300 (made by Neos Co., Ltd).

Resin particles can be used to stabilize the base particles formed in the aqueous medium and to prevent the exposure of the paraffin wax on the toner surface. In order to prevent the exposure in this way, it is preferable that the polymer particles be added in an amount so that the coverage of the base particle surface is from 10% to 90%. Specific examples of the polymer particles include particulate polymethacrylate, particulate polystyrene, particulate styrene acrylonitrile copolymer. Specific examples of product names include PB-200H (made by Kao Co., Ltd.), SGP (made by Soken Chemical & Engineering Co., Ltd), TECHNOPOLYMER SB (made by Sekisui Plastics Co., Ltd.), SPG-3G (made by Soken Chemical & Engineering Co., Ltd), and MICROPEARL (Sekisui Fine Chemical Co., Ltd).

The polymer particles have a glass transition point (Tg) that is preferably from 50° C. to 110° C., more preferably from 50° C. to 90° C., and even more preferably from 50° C. to 70° C. When the glass transition point (Tg) is less than 50° C., the heat resistance/storage stability of the toner may deteriorate and the toner may become fixed or condensed in toner collection channels. When the glass transition point (Tg) exceeds 110° C., the toner bindability with a toner fixing paper is impaired, causing a minimum fixing temperature to increase.

The weight-average molecular weight of the polymer particles is preferably 100,000 or less, and more preferably 50,000 or less. Typically, 4,000 is preferable as a lower limit for the weight-average molecular weight. When the weight-average molecular weight exceeds 100,000, the toner bindability with a toner fixing paper may be impaired, causing the minimum fixing temperature to increase.

The resin constituting the polymer particles can be any known resin capable of forming an aqueous dispersion. Examples of such resins include vinyl resins, polyurethane, epoxy resins and polyesters, but any other thermoplastic resin or thermosetting resin with the above property is acceptable. Of these, the vinyl resins, polyurethanes, epoxy resins, and polyesters are preferable since an aqueous dispersion of fine spherical polymer particles is easily prepared with these materials. A resin formed from a combination of these materials may also be used. This resin may include two or more of the above materials.

Examples of the vinyl resins are homopolymers or copolymers of vinyl monomers, such as styrene-acrylic ester copolymer, styrene methacrylic ester copolymer, styrene-butadiene copolymers, acrylic acid-acrylic ester copolymers, methacrylic acid-acrylic ester copolymers, styrene-acrylonitrile copolymers, styrene-maleic anhydride copolymers, styrene-acrylic acid copolymers, and styrene-methacrylic acid copolymers.

The volume average particle diameter of the polymer particles is preferably from 10 nm to 200 nm and more preferably from 20 nm to 80 nm. A light scattering spectrometer (made by Otsuka Electronics Co., Ltd.) can be used to measure the volume-average particle diameter.

Inorganic compounds such as tricalcium phosphate, calcium carbonate, titanium oxide, colloidal silica, and hydroxyapatite can also be used as the dispersant.

A polymeric protective colloid may be used together with the inorganic compound dispersants and the polymer particles. Examples of materials for use in the protective colloid include homopolymers or copolymers of: acids such as acrylic acid, methacrylic acid, α-cyanoacrylic acid, α-cyanomethacrylic acid, itaconic acid, crotonic acid, fumaric acid, maleic acid, and maleic anhydride; hydroxyl-group-containing (meth) acrylic monomers such as β-hydroxyethyl acrylate, β-hydroxyethyl methacrylate, β-hydroxypropyl acrylate, p-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic ester, diethylene glycol monomethacrylic ester, glycerol monoacrylic ester, glycerol monomethacrylic ester, N-methylolacrylamide, and N-methylolmethacrylamide; vinyl alcohol and ethers thereof such as vinyl methyl ether, vinyl ethyl ether, and vinyl propyl ether; esters of vinyl alcohol such as vinyl acetate, vinyl propionate, and vinyl butyrate; acrylamide, methacrylamide, diacetone acrylamide, and methylol compounds thereof; acid chlorides such as acryloyl chloride, and methacryloyl chloride; vinylpyridine, vinylpyrrolidone, vinylimidazole, ethyleneimine and the like which are nitrogen-containing compounds optionally having a heterocyclic ring. Examples of the polymer substance also include polyoxyethylene compounds such as polyoxyethylene, polyoxypropylene, polyoxyethylene alkyl amines, polyoxypropylene alkyl amines, polyoxyethylene alkyl amides, polyoxypropylene alkyl amides, polyoxyethylene nonyl phenyl ether, polyoxyethylene lauryl phenyl ether, polyoxyethylene stearyl phenyl ester, and polyoxyethylene nonyl phenyl ester; and cellulose derivatives such as methyl cellulose, hydroxyethyl cellulose, and hydroxypropyl cellulose.

The dispersion method is not specifically limited and includes known methods such as low-speed shearing, high-speed shearing, dispersing by friction, high-pressure jetting, and ultrasonic dispersion. To allow the dispersion to have an average particle diameter of 2 μm to 20 μm, the high-speed shearing procedure is preferred. When a high-speed shearing dispersing machine is used, the rotation speed is not specifically limited, but is generally preferably from 1,000 rpm to 30,000 rpm and more preferably from 5,000 rpm to 20,000 rpm. The dispersion time is not specifically limited, but in a batch system is generally from 0.1 minute to 5 minutes. The dispersing temperature is generally preferably from 0° C. to 150° C. (under pressure), and more preferably from 40° C. to 98° C.

(3) The amine (B) is added to the emulsion and reacted with the isocyanate group-containing prepolymer (A).

This reaction involves cross-linking and/or extension of molecular chains. The reaction time for the extension and/or crosslinking is appropriately set depending on the reactivity between the isocyanate structure of the polyester prepolymer (A) and the amine (B), and is generally preferably from 10 minutes to 40 hours and more preferably from 2 hours to 24 hours. The reaction temperature is generally preferably from 0° C. to 150° C., and more preferably from 40° C. to 98° C. Where necessary, a known catalyst such as dibutyltin laurate or dioctyltin laurate can be used.

(4) When the reaction between the isocyanate group-containing prepolymer (A) and the amine (B) has completed, base particles are prepared by removing organic solvent from the prepared emulsion, followed by cleaning and drying.

The organic solvent is removed after gradually elevating the temperature of the entire system in a layer-flow stirring state, and strongly stirring while keeping the emulsion temperature within a fixed temperature band. This method results in spindle-shaped base particles. When a calcium phosphate or another dispersion stabilizer that is soluble in acids or bases is used, the dispersion stabilizer may be removed from the base particles by dissolving the dispersion stabilizer using an acid such as hydrochloric acid and washing the base particles. Alternatively, the dispersion stabilizer can be removed by enzyme-catalyzed decomposition.

(5) To prepare the toner, the prepared base particles are mixed with a charge controlling agent and an inorganic particles such as silica particles or titanium oxide particles.

The charge controlling agent and the inorganic particles are according to a known method using a mixer or the like. The above methods enable easy preparation of a toner having a small particle diameter and sharp particle diameter distribution. Also, through strong stirring during the process to remove the organic solvent, it is possible to control the shape of base particles from spherical shape to rugby-ball shape, and to control the surface morphology.

The toner of the present invention can be used in a developer for developing latent electrostatic images in such applications as electronic photography, electrostatic recording, and electrostatic printing. The toner of the present invention can be used alone as a one-component developer or mixed with a conventional carrier to form a two-component developer. When the toner is used as part of a two-component developer for a full color image forming device, it is preferable that the concentration of the toner in the developer is from 3% by mass to 12% by mass. The toner concentration in the developer is set, based on the toner and carrier particle diameters and specifically their surface areas, so that toner occupies 100% or less of the carrier surface. Thus, sufficient contact is maintained between the toner and the carrier, and it is possible to prevent insufficient charging of toner that results from a poor contact between toner and carrier. When the concentration of toner in the developer exceeds 12% by mass, toner ingredients such as a paraffin wax and resin may become fixed to the carrier surface, causing a reduction in the carrier chargeability.

The present invention provides a toner that has a small particle diameter, narrow particle diameter distribution and excellent low temperature fixability, and is capable of suppressing a drop in chargeability even after long periods of use. The present invention further provides a developer including the toner.

### EXAMPLES

Examples of the present invention will be described below, which however shall not be construed as limiting the scope of the present invention. In the following Examples, “parts” denotes “parts by mass” unless otherwise indicated.

### Example 1

### Preparation of Organic Fine Particle Emulsion

In a reactor equipped with a stirring rod and a thermometer were placed in a mixture of 683 parts water, 11 parts sodium salt of methacrylic acid-ethyleneoxide adduct sulfate (ELEMINOL RS-30 made by Sanyo Chemical Industries, Ltd.), 83 parts styrene, 83 parts methacrylate, 110 parts butyl acrylate and 1 part ammonium persulfate, and the mixture was stirred at 3,800 rpm for 30 minutes to yield a white emulsion. The emulsion was heated to an inner temperature of 75° C. and allowed to react for 4 hours. The reaction mixture was further treated with 30 parts of a 1% by mass aqueous solution of ammonium persulfate, was aged at 75° C. for 6 hours, and thereby yielded an aqueous dispersion (polymerparticle dispersion 1) of a vinyl resin (a copolymer of styrene-methacrylic acid-butyl acrylate-sodium sulfate ester of methacrylic acid-ethylene oxide adduct).

The polymer particle dispersion 1 had a volume-average particle diameter of 110 nm as determined using a laser diffraction-scattering size distribution analyzer (LA-920, made by Horiba, Ltd.). A portion of the Polymer Particle Dispersion 1 was dried to isolate a resin component. The resin component had a glass transition point (Tg) of 58° C., and a weight-average molecular weight of 130,000.

(Preparation of Aqueous Phase)

A white emulsion (aqueous phase 1) was prepared by blending and stirring 990 parts of water, 83 parts of the Polymer Particle Dispersion 1, 37 parts of a 48.3% by mass aqueous solution of sodium dodecyl diphenyl ether disulfonate (ELEMINOL MON-7 made by Sanyo Chemical Industries, Ltd.), and 90 parts of ethyl acetate.

(Preparation of Low Molecular Weight Polyester 1)

In a reactor equipped with a condenser, a stirrer and a nitrogen gas feed tube were placed 724 parts of ethylene oxide (2 mole) adduct of bisphenol A, and 276 parts of terephthalic acid. The mixture was polymerized by condensation at 230° C. for 7 hours and further reacted at a reduced pressure of from 10 mmHg to 15 mmHg for 5 hours, to yield the low molecular weight polyester 1. The low molecular weight polyester 1 had a number-average molecular weight of 2,300, a weight-average molecular weight of 6,700, a peak molecular weight of 3,800, a glass transition point (Tg) of 43° C., and an acid value of 4 mg KOH/g.

(Preparation of Intermediate Polyester)

In a reactor equipped with a condenser, a stirrer and a nitrogen gas feed tube were placed 682 parts of ethylene oxide (2, mole) adduct of bisphenol A, 81 parts of propylene oxide (2 mole) adduct of bisphenol A, 283 parts of terephthalic acid, 22 parts of trimellitic anhydride, and 2 parts of dibutyltin oxide. The mixture was reacted at 230° C. for 7 hours and further reacted under a reduced pressure of from 10 mmHg to 15 mmHg for 5 hours, to yield an intermediate polyester 1.

The intermediate polyester 1 had a number-average molecular weight of 2,200, a weight-average molecular weight of 9,700, a peak molecular weight of 3,000, a glass transition point (Tg) of 54° C., an acid value of 0.5 mg KOH/g, and a hydroxyl group value of 52 mg KOH/g.

Next, in a reactor equipped with a condenser, a stirrer and a nitrogen gas feed tube were placed 410 parts of the intermediate polyester 1, 89 parts of isophoronediisocyanate, and 500 parts of ethyl acetate. The mixture was reacted at 100° C. for 5 hours to provide prepolymer 1. The prepolymer 1 contained 1.53% by mass of free isocyanate.

(Preparation of Ketimine Compound)

In a reactor equipped with a stirring rod and a thermometer were placed 170 parts of isophoronediamine and 75 parts of methyl ethyl ketone. The mixture was then reacted at 50° C. for 4.5 hours to yield ketimine compound 1. The amine value for the ketimine compound 1 was 417 mg KOH/g.

(Preparation of Master Batch)

A total of 1,200 parts of water, 540 parts of carbon black (Printex 35 made by Degussa AG; DBP oil absorbance: 42 ml/100 mg; pH: 9.5), and 1,200 parts of a low molecular polyester 1 were mixed using a HENSCHEL MIXER (made by Mitsui Mining Co., Ltd). After kneading at 130° C. for 1 hour using a two roll mill, the mixture was cold-rolled and then pulverized in a pulverizer to yield Master Batch 1.

(Preparation of Oil Phase)

In a reactor equipped with a stirring rod and a thermometer were placed 378 parts of the low molecular weight polyester 1, 100 parts of paraffin wax with a melting point of 70° C. (HNP-11 made by Nippon Seiro Co., Ltd.), and 947 parts of ethyl acetate 947. The mixture was heated to and held at 80° C. for 5 hours while being stirred, and then cooled to 30° C. over 1 hour. The mixture was then treated with 500 parts of the Master Batch 1, 30 parts of organically-modified montmorillonite and 500 parts of ethyl acetate with stirring for 1 hour to yield a material solution 1.

Next, 1,324 parts of the material solution 1 were placed in a vessel, and the carbon black and wax components therein were dispersed using a bead mill (ULTRAVISCO MILL made by Aimex Co., Ltd.) at a liquid feeding speed of 1 kg/hr, a disc circumferential speed of 6 m/sec, filled 80% by volume with 0.5 mm diameter zirconium beads. The procedure was repeated three times to disperse the carbon black and wax. Next, 1,324 parts of the 65% by mass ethyl acetate solution of the low molecular weight polyester 1 were added to the dispersion, and the mixture was dispersed with two repetitions of the above described procedures using the bead mill, to a yield pigment wax dispersion 1 having a solid content of 50% by mass.

(Emulsification to Solvent Removal)

In a vessel were placed 749 parts of the pigment wax dispersion 1, 115 parts of the prepolymer 1, and 2.9 parts of the ketimine compound 1, and the mixture was mixed at 5,000 rpm for 2 minutes using a T.K. HOMO MIXER (made by Tokushu Kika Kogyo Co., Ltd.). Next, the mixture was treated with 1,200 parts of the aqueous phase 1 by mixing at 13,000 rpm for 25 minutes using the T.K. HOMO MIXER, to yield an emulsified slurry 1.

The emulsified slurry 1 was placed in a vessel equipped with a stirrer and a thermometer, and heated at 30° C. for 7 hours to remove the solvent. Thereafter the resultant slurry was aged at 45° C. for 7 hours to yield a dispersed slurry 1.

(Washing to Drying)

A total of 100 parts of the dispersed slurry 1 was filtered under a reduced pressure, and then washed by the following procedures.

(I) The filtered cake and 100 parts of deionized water were mixed in a T.K. HOMO MIXER at 12,000 rpm for 10 minutes, and the resultant mixture was filtered.

(II) The filtered cake prepared in (I) and 100 parts of a 10% by mass aqueous solution of sodium hydroxide were mixed in a T.K. HOMO MIXER at 12,000 rpm for 10 minutes, and the resultant mixture was filtered under a reduced pressure.

(III) The filtered cake prepared in (II) and 100 parts of a 10% by mass hydrochloric acid were mixed in a T.K. HOMO MIXER at 12,000 rpm for 10 minutes, and the resultant mixture was filtered.

(IV) The filtered cake prepared in (III) and 300 parts of ion-exchanged water were mixed in a T.K. HOMO MIXER at 12,000 rpm for 10 minutes, and the resultant mixture was filtered. This washing procedure was further repeated twice to yield a filtered cake 1.

The filtered cake 1 was dried at 45° C. for 48 hours in a circulating air dryer and sieved through a 75 μm mesh sieve, to yield base particles 1. Next, 100 parts of the base particles 1 are mixed, using a HENSCHEL MIXER, with 1 part of hydrophobic silica having an average primary particle diameter of 15 nm and 1 part of hydrophobic titanium oxide having an average primary particle diameter of 15 nm, thereby forming a toner.

### Example 2

A toner was prepared in the same way as in Example 1 except in that the amount of added organically-modified montmorillonite was changed from 30 parts to 48 parts.

### Example 3

A toner was prepared in the same way as in Example 1 except in that the amount of added organically-modified montmorillonite was changed from 30 parts to 12 parts.

### Example 4

In a reactor equipped with a condenser, a stirrer and a nitrogen gas feed tube were placed 690 parts of ethylene oxide (2 mole) adduct of bisphenol A, and 335 parts of terephthalic acid. The mixture was reacted by condensation at 210° C. at under a nitrogen flow for 10 hours. The mixture was further reacted under a reduced pressure of 10 mmHg to 15 mmHg for 5 hours while removing the water, and then cooled to yield a low molecular weight polyester 2. The low molecular weight polyester 2 had a weight-average molecular weight of 6,000, an acid value of 20 mg KOH/g, and a glass transition point (Tg) of 55° C.

Except using the low molecular weight polyester 2 in place of the low molecular weight polyester 1, a toner of Example 4 was prepared in the same manner as the toner of Example 1.

### Example 5

Except using the (emulsifying and solvent removal) process described below, the preparation of the toner of the Example 5 is identical to that of Example 1.

In a vessel were placed 749 parts of the pigment wax dispersion 1, 115 parts of the prepolymer 1, and 2.9 parts of the ketimine compound 1, and the mixture was mixed for 2 minutes using a T.K. HOMO MIXER (made by Tokushu Kika Kogyo Co., Ltd.). Next, the mixture was treated with 1,200 parts of the aqueous phase 1 by mixing for 25 minutes using the T.K. HOMO MIXER, to yield an emulsified slurry 1.

The emulsified slurry 1 was placed in a vessel equipped with a stirrer and a thermometer, and heated at 30° C. for 7 hours to remove the solvent. Thereafter, the resultant slurry was aged at 45° C. for 7 hours to yield a dispersed slurry 1.

### Comparative Example 1

A toner was prepared in the same way as in Example 1 except in that montmorillonite was not added.

### Comparative Example 2

A toner was prepared in the same way as in Example 1 except in that carnauba wax with a melting point of 70° C. was used in place of the paraffin wax with a melting point of 70° C.

### Comparative Example 3

A toner was prepared in the same way as in Example 1 except in that the organically-modified montmorillonite was not added and paraffin wax having a melting point of 100° C. was used in place of the paraffin wax having a melting point of 70° C.

### Comparative Example 4

A toner was prepared in the same way as in Example 1 except in that the organically-modified montmorillonite was not added and carnauba wax having a melting point of 70° C. was used in place of the paraffin having a melting point of 70° C.

### Comparative Example 5

A toner was prepared in the same way as in Example 1 except in that the added amount of the paraffin having a melting point of 70° C. was changed from 100 parts to 150 parts.

### Comparative Example 6

A toner was prepared in the same way as in Example 1 except in that the added amount of the paraffin having a melting point of 70° C. was changed from 100 parts to 50 parts.

[Evaluation Method and Results]

Characteristics of the base particles prepared in Examples 1 to 5 and Comparative Examples 1 to 6 are shown in table 1 below.

TABLE 1

| | | | | | | | | Endotherm at | | |
|---|---|---|---|---|---|---|---|---|---|---|
| | | | | | | | | endothermic peak | | Content of base particles |
| | D/S | L/M | Average | SF1 | SF2 | D4 | D4/Dn | derived from wax | Tg | with diameter of 2 μm |
| | (%) | (—) | circularity | (—) | (—) | (μm) | (—) | (J/g) | (° C.) | or more (% by number) |
| Ex. 1 | 20 | 4 | 0.960 | 149 | 120 | 5.8 | 1.2 | 3.8 | 52 | 6 |
| Ex. 2 | 37 | 12 | 0.945 | 156 | 138 | 5.8 | 1.24 | 3.8 | 49 | 8 |
| Ex. 3 | 17 | 3 | 0.970 | 133 | 113 | 5.8 | 1.22 | 3.8 | 49 | 7 |
| Ex. 4 | 22 | 4 | 0.962 | 146 | 118 | 5.6 | 1.22 | 4.0 | 58 | 8 |
| Ex. 5 | 21 | 4 | 0.961 | 152 | 126 | 5.8 | 1.21 | 3.7 | 49 | 8 |
| Com. Ex. 1 | 7 | 1.9 | 0.986 | 128 | 109 | 5.9 | 1.21 | 4 | 48 | 8 |
| Com. Ex. 2 | 18 | 4 | 0.962 | 146 | 119 | 5.8 | 1.17 | 4.2 | 50 | 6 |
| Com. Ex. 3 | 9 | 1.9 | 0.988 | 126 | 108 | 5.7 | 1.15 | 3.8 | 50 | 7 |
| Com. Ex. 4 | 7 | 1.8 | 0.987 | 128 | 108 | 5.8 | 1.19 | 4.1 | 50 | 8 |
| Com. Ex. 5 | 18 | 4 | 0.961 | 146 | 122 | 5.7 | 1.2 | 6.0 | 50 | 7 |
| Com. Ex. 6 | 18 | 5 | 0.960 | 147 | 124 | 5.8 | 1.2 | 1.9 | 50 | 6 |

(Preparation of Carrier)

A dispersion of 21.0 parts of an acrylic resin solution containing 50% by mass solids, 6.4 parts of a guanamine solution containing 70% by mass solids, 7.6 parts of aluminum particles (average particle diameter 0.3 μm, specific resistance 10¹⁴ Ω·cm), 65.0 parts of silicone resin solution containing 23% by mass solids (SR2410 made by Dow Corning Toray Co., Ltd.), 0.3 parts of amino silane (SH6020 made by Dow Corning Toray Co., Ltd.), 60 parts of toluene, and 60 parts of butyl cellosolve was formed by mixing for 10 minutes with a homomixer, to yield a coating forming solution.

A baked ferrite powder (MgO)_{1.8}(MnO)_{49.5}(Fe₂O₃)_{48.0} with an average particle diameter of 35 μm was used as a core material. The coating forming solution was applied onto the surface of the core material using a spillercoater (made by Okada Seiko Co., Ltd.) to give a coating thickness of 0.15 μm, and the resultant particles were dried. The resultant particles were then baked at 150° C. for 1 hour in an electric oven. After cooling, the particles were sieved through a sieve with a 106 μm mesh to yield a carrier 1.

The coating thickness was taken to be an average coating thickness obtained through observation of cross sections of particles of carrier 1 using a penetration electron microscope.

(Preparation of Developer)

The toners prepared in Examples or Comparative Examples and the carrier 1 are mixed for 10 minutes in a tabular mixer at maximum stirring strength so that the toner concentration is 3% by mass or 12% by mass, thereby yielding developers. The following evaluation was performed using the prepared developer. The results of the evaluation are shown in Table 2.

TABLE 2

| | | | Reduced charge | Reduced charge |
|---|---|---|---|---|
| | | | capacity of carrier | capacity of carrier |
| | Cold offset | Hot offset | (toner | (toner |
| | temperature | temperature | concentration | concentration |
| | (° C.) | (° C.) | 3 wt %) | 12 wt %) |
| Ex. 1 | 140 | 200 | A | A |
| Ex. 2 | 140 | 200 | A | A |
| Ex. 3 | 140 | 200 | A | B |
| Ex. 4 | 155 | 200 | A | A |
| Ex. 5 | 140 | 195 | A | A |
| Com. | 140 | 200 | B | C |
| Ex. 1 | | | | |
| Com. | 140 | 175 | A | A |
| Ex. 2 | | | | |
| Com. | 140 | 180 | A | A |
| Ex. 3 | | | | |
| Com. | 140 | 175 | A | A |
| Ex. 4 | | | | |
| Com. | 140 | 210 | A | C |
| Ex. 5 | | | | |
| Com. | 140 | 175 | A | A |
| Ex. 6 | | | | |

(Evaluation of Fixability)

Fixing tests were performed by passing type 6200 paper (made by Ricoh Co., Ltd.) having thereon an unfixed image (2 cm×7 cm rectangular solid image with a deposited toner amount of 1.0 mg/cm²) through a modified fixing unit of a copier (MF 2200 made by Ricoh Co., Ltd.) equipped with Teflon(R) fixing rollers. Specifically, the fixing temperature was varied in 5° C. steps to find the cold offset generation temperature and hot offset generation temperature. Conditions of the fixing rollers for the evaluation of low temperature fixing were as follows: linear velocity for paper transfer=120 mm/sec, surface pressure=1.2 kgf/cm², and nip width=3 mm. And, conditions of the fixing rollers for the evaluation of high temperature fixing were as follows: linear velocity for paper transfer=50 mm/sec, surface pressure=2.0 kgf/cm², and nip width=4.5 mm. A hot offset generation temperature of less than 180° C. results in failure to ensure sufficient fixability.

(Reduction in Chargeability of Carrier)

After outputting 30,000 sheets continuously, each having an image chart covering 50% of its surface, using a digital full color copier (imagio Color 2800, made by Ricoh Co., Ltd.) in a 25° C. and 50% humidity environment, a portion of each developer was sampled for the measurement of the amount of charge using a blow-off method to evaluate reduction in the carrier chargeability based on the following criteria. This test was performed twice, with a toner concentration of 3% by mass and with a toner concentration of 12% by mass.

[Evaluation Criteria]

When the change in the amount of charge between before and after continuous output of 30,000 sheets was less than 5 μC/g, the carrier chargeability was ranked “A”; when the change was from 5 μC/g to 10 μC/g, it was ranked “B”; and when the change was greater than 10 μC/g, it was ranked “C”.

What is claimed is:

1. A toner comprising:
base particles, each containing a binder resin and a paraffin wax,
wherein the base particle has a paraffin wax-originated endotherm from 2.0 J/g to 5.5 J/g at an endothermic peak as measured by DSC, an average circularity from 0.94 to 1.00, and a contact area-to-whole projected area ratio from 15% to 40%.

2. The toner according to claim 1, wherein the paraffin was has a melting point from 60° C. to 90° C.

3. The toner according to claim 1, wherein the whole projected area and the contact area are measured by sieving the base particles through a 22 μm mesh for 10 seconds at a position 10 cm above a substantially horizontally disposed flat glass plate so as to cause the base particles to drop onto the flat glass plate.

4. The toner according to claim 1, wherein the base particle is prepared by dispersing in an aqueous medium a dispersion liquid that contains at least a polyester prepolymer having a nitrogenous functional group, a polyester, a colorant, the paraffin wax, and an inorganic filler dispersed in an organic solvent, to cause at least one of cross-linking and extension reactions of the polyester prepolymer, and
wherein the base particle has a shape factor SF1 from 130 to 160 and a shape factor SF2 from 110 to 140.

5. The toner according to claim 4, wherein the inorganic filler is one of montmorillonite and modified montmorillonite.

6. The toner according to claim 1, wherein the base particle has a weight-average particle diameter (D4) from 3 μm to 8 μm, and a weight-average particle diameter (D4)-to-number-average diameter (Dn) ratio (D4/Dn) ranging from 1.00 to 1.30.

7. The toner according to claim 1, further comprising particles having an average primary particle diameter from 50 nm to 500 nm.

8. The toner according to claim 1, wherein the base particle has a glass transition point from 40° C. to 60° C.

9. The toner according to claim 1, wherein base particles having a particle diameter of 2 μm or less accounts for from 1% to 10% by number of the total base particles.

10. A developer comprising:
a carrier; and
a toner that comprises base particles, each containing a binder resin and a paraffin wax,
wherein the base particle has a paraffin wax-originated endotherm from 2.0 J/g to 5.5 J/g at an endothermic peak as measured by DSC, an average circularity from 0.94 to 1.00, and a contact area to whole projected area ratio from 15% to 40%.
